(19) United States
(12) Patent Application Publication
(10) Pub. No.: US 2026/0196486 A1
(43) Pub. Date: Jul. 9, 2026

(54) POSITIVE ELECTRODE ACTIVE MATERIAL AND POSITIVE ELECTRODE INCLUDING THE SAME, AND ELECTRICAL ENERGY STORAGE DEVICE

(71) Applicant: Prime Planet Energy & Solutions, Inc., Tokyo (JP)

(72) Inventor: Keiichi TAKAHASHI, Nishinomiya-shi (JP)

(21) Appl. No.: 19/432,927

(22) Filed: Dec. 25, 2025

(30) Foreign Application Priority Data
Jan. 9, 2025 (JP) 2025-003389

(51) Int. Cl. H01M 4/36; H01M 4/02; H01M 4/525

(52) U.S. Cl. CPC H01M 4/366; H01M 4/525; H01M 2004/028

(57) ABSTRACT

A positive electrode active material disclosed herein includes a Ni-containing lithium transition metal complex oxide in a particle form, a first coating part that includes a coating oxide including a lithium element and a coating element, and a second coating part that includes a boron-containing compound. A boron coating ratio based on X-ray photoelectron spectroscopy is 90 mol % or more.

### CROSS REFERENCE TO RELATED APPLICATION

This application claims the benefit of priority to Japanese Patent Application No. 2025-003389 filed on Jan. 9, 2025. The entire contents of this application are hereby incorporated herein by reference.

### BACKGROUND OF THE DISCLOSURE

### 1. Field

The present disclosure relates to a positive electrode active material and a positive electrode including the same, and an electrical energy storage device.

### 2. Background

Conventionally, a lithium transition metal complex oxide has been widely used as a positive electrode active material of an electrical energy storage device (for example, see Japanese Translation of PCT International Application Publication No. 2024-512946, Japanese Patent Application Publication No. 2021-072193, and Japanese Patent No. 6284542). In addition, from the viewpoints of increasing the capacity, and the like, using a lithium transition metal complex oxide with higher Ni content has been examined in recent years. For example, Japanese Translation of PCT International Application Publication No. 2024-512946 discloses a positive electrode active material including a lithium transition metal complex oxide particle containing 60 mol % or more of Ni, and a coating layer provided on a surface of the lithium transition metal complex oxide particle and including a predetermined coating oxide. According to Japanese Translation of PCT International Application Publication No. 2024-512946, the stability of the positive electrode active material is increased by the provision of the coating layer and the capacity retention after 30 cycles can be improved.

### SUMMARY

For example, a high-output type electrical energy storage device that is mounted on a mobile body such as a vehicle is required to exhibit the excellent output characteristic for a long time.

The present disclosure provides a positive electrode active material including: a Ni-containing lithium transition metal complex oxide in a particle form containing 70 mol % or more of nickel relative to metal elements other than lithium; a first coating part that coats a surface of a part of the Ni-containing lithium transition metal complex oxide and includes a coating oxide including a lithium element and at least one coating element among manganese, cobalt, molybdenum, tin, and titanium; and a second coating part that coats a surface of at least a part of the first coating part and the Ni-containing lithium transition metal complex oxide and includes a boron-containing compound. A region of an outermost surface in a part of the surface of the Ni-containing lithium transition metal complex oxide where the first coating part is not provided is measured by X-ray photoelectron spectroscopy and when a total of the metal elements other than lithium included in the Ni-containing lithium transition metal complex oxide and the boron element included in the second coating part in the region is 100 mol %, a boron coating ratio obtained as a ratio of the boron element is 90 mol % or more.

According to the positive electrode active material with the aforementioned structure, an electrical energy storage device that can exhibit the excellent output characteristic for a long time can be suitably achieved.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view schematically illustrating a positive electrode active material according to an embodiment;

FIG. 2 is a cross-sectional view schematically illustrating an internal structure of an electrical energy storage device according to an embodiment; and

FIG. 3 shows a Raman spectrum in Example 1.

### DETAILED DESCRIPTION OF THE PREFERRED EMBODIMENTS

Hereinafter, some preferred embodiments of the art disclosed herein will be described with reference to the drawings as appropriate. Matters other than matters particularly mentioned in the present specification and necessary for the implementation of the art disclosed herein (for example, the general configuration and manufacturing process of an electrical energy storage device that do not characterize the art disclosed herein) can be grasped as design matters of those skilled in the art based on the prior art in the relevant field. The art disclosed herein can be implemented on the basis of the disclosure of the present specification and common technical knowledge in the relevant field. Note that in the drawings below, the members and parts with the same operation are denoted by the same reference sign and the overlapping description may be omitted or simplified.

Moreover, in the present specification, “electrical energy storage device” refers to a general device capable of being repeatedly charged and discharged by transfer of charge carriers between a positive electrode and a negative electrode through an electrolyte. The electrical energy storage device refers to a concept that encompasses a secondary battery such as a lithium ion secondary battery or a nickel hydrogen battery, and a capacitor using a chemical reaction, such as a lithium ion capacitor or a pseudo-capacitor. Additionally, in the present specification, the notation “A to B” for a range signifies a value more than or equal to A and less than or equal to B, and is meant to encompass also the meaning of being “more than A” and “less than B”.

### [Positive Electrode Active Material]

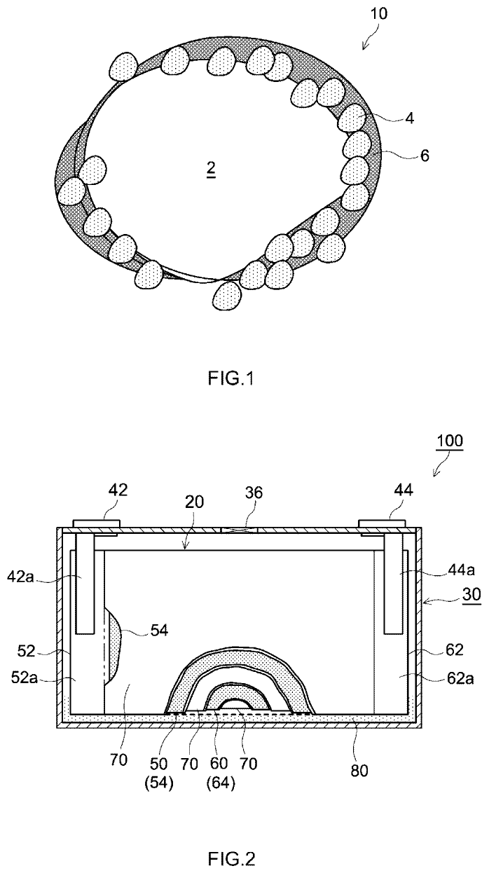

FIG. 1 is a cross-sectional view schematically illustrating a positive electrode active material 10 according to an embodiment. The positive electrode active material 10 can be suitably used for a positive electrode of an electrical energy storage device. The positive electrode active material 10 is a so-called core-shell particle. The positive electrode active material 10 includes a Ni-containing lithium transition metal complex oxide 2 in a particle form, which serves as a base material, a first coating part 4 that coats a surface of a part of the Ni-containing lithium transition metal complex oxide 2, and a second coating part 6 that coats a surface of at least a part of the first coating part 4 and the Ni-containing lithium transition metal complex oxide 2. Note that FIG. 1 illustrates just one example and the positive electrode active material 10 is not limited to the illustrated one.

The Ni-containing lithium transition metal complex oxide 2 is a complex oxide including Li and Ni as necessary elements. In this embodiment, the Ni-containing lithium transition metal complex oxide 2 contains Ni by 70 mol % or more relative to the total of metal elements other than lithium (typically, transition metal elements) from the viewpoints of improving the battery capacity and the energy density, and the like. The Ni content is preferably 75 mol % or more and more preferably 80 mol % or more. According to the present inventor's knowledge, the lithium transition metal complex oxide with the high Ni content is relatively highly reactive and its long-term durability tends to decrease, as compared to a lithium complex oxide with the low Ni content. In addition, a relatively larger amount of gas tends to be generated by a side reaction with the electrolyte. Thus, it is particularly effective to apply the art disclosed herein.

Specific examples of the Ni-containing lithium transition metal complex oxide 2 include lithium nickel complex oxides, lithium nickel cobalt complex oxides, lithium nickel manganese complex oxides, lithium nickel cobalt manganese complex oxides, lithium nickel cobalt aluminum complex oxides, lithium iron nickel manganese complex oxides, and the like. Any of these may be used alone or two or more kinds may be used in combination. It is preferable that the Ni-containing lithium transition metal complex oxide 2 include at least one kind of Co and Mn in addition to Ni as the transition metal element. In particular, a lithium nickel cobalt manganese complex oxide including Ni, Co, and Mn is preferable for its excellent battery characteristics.

Note that, in the present specification, the term “lithium nickel cobalt manganese complex oxide” encompasses oxides including Li, Ni, Co, Mn, and O as constituent elements and moreover oxides including one kind or two or more kinds of additive elements other than those above. Examples of such additive elements include transition metal elements, typical metal elements, and the like including Mg, Ba, Sr, Ca, Al, Ti, V, Cr, Y, Zr, Nb, Mo, Hf, Ta, W, Na, K, Fe, Cu, Zn, Sn, and the like. The additive element may be a metalloid element such as B, C, Si, or P or a non-metallic element such as S, F, Cl, Br, or I. This similarly applies to the lithium nickel complex oxides, the lithium nickel cobalt complex oxides, the lithium nickel manganese complex oxides, the lithium nickel cobalt aluminum complex oxides, the lithium iron nickel manganese complex oxides, and the like described above.

In some embodiments, the lithium nickel cobalt manganese complex oxide preferably has a composition expressed by the following Formula (I):

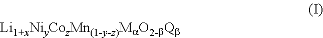

In the above Formula (I), x, y, z, α, and β satisfy −0.3≤x≤0.3, 0.7≤y≤1.0, 0<z≤0.3, 0<(1−y−z), 0≤α≤0.1, and 0≤β≤0.5. When 0<α, M represents at least one kind of element selected from the group consisting of Al, Zr, B, Mg, Fe, Cu, Zn, Sn, Na, K, Ba, Sr, Ca, W, Mo, Nb, Ti, and Si. When 0<β, Q represents at least one kind of element selected from the group consisting of F, Cl, and Br.

Note that in the above Formula (I), x satisfies preferably 0≤x≤0.2 and more preferably 0≤x≤0.1, y satisfies preferably 0.75≤y, more preferably 0.8≤y, and for example 0.8≤y≤0.9, z satisfies preferably 0.01≤z, more preferably 0.03≤z≤0.2, and for example 0.05≤z≤0.1, and (1−y−z) satisfies preferably 0.01≤(1−y−z)≤0.3 and more preferably 0.03≤(1−y−z)≤0.2. In addition, a satisfies preferably 0≤α≤0.05 and is more preferably 0. Furthermore, β satisfies preferably 0≤β≤0.1 and is more preferably 0.

The Ni-containing lithium transition metal complex oxide 2 preferably has a layered rock-salt type crystal structure. Examples of the lithium complex oxide with such a crystal structure include lithium nickel cobalt manganese complex oxides, lithium nickel cobalt aluminum complex oxides, and the like. However, the crystal structure of the Ni-containing lithium transition metal complex oxide 2 may be a spinel structure or the like. Note that the crystal structure of the Ni-containing lithium transition metal complex oxide 2 can be checked by an X-ray diffraction method.

The Ni-containing lithium transition metal complex oxide 2 is in a particle form. The shape of the Ni-containing lithium transition metal complex oxide 2 here has a substantially spherical shape, although there is no particular limitation. Note that, in the present specification, the term “substantially spherical shape” means a shape that can be regarded as being generally spherical as a whole and that has an average aspect ratio (major axis/minor axis ratio) of generally 1 to 2 and for example 1 to 1.5 in a cross-sectional observation image with an electron microscope (for example, scanning electron microscope).

In some embodiments, the Ni-containing lithium transition metal complex oxide 2 is preferably in a single particle form. Note that, in the present specification, the term “single particle” refers to a particle without a crystal grain boundary. The number of primary particles included in a single particle is typically 10 or less, and for example one primary particle may exist alone or a plurality of (for example, about two to five) primary particles may exist in an aggregated state. The number of primary particles in the Ni-containing lithium transition metal complex oxide 2 can be confirmed by analyzing an electron beam diffraction image with an electron microscope (for example, scanning electron microscope). Note that, in the present specification, the term “primary particle” refers to the minimum unit of particles forming the Ni-containing lithium transition metal complex oxide 2 and specifically, the minimum unit determined based on the apparent geometric mode that is recognized under the electron microscope observation. In addition, the Ni-containing lithium transition metal complex oxide 2 in the single particle form can be manufactured in accordance with a known method of obtaining a single crystal particle.

An average particle diameter D₀ of the Ni-containing lithium transition metal complex oxide 2 is preferably 1 to 7 μm, more preferably 2 to 6 μm, and still more preferably 3 to 5 μm, although there is no particular limitation. Moreover, the average primary particle diameter of the primary particles included in the Ni-containing lithium transition metal complex oxide 2 is preferably 0.1 to 2 μm or more and more preferably 0.2 to 1 μm. Note that, in the present specification, the term “average particle diameter” refers to the arithmetic average value of major axes of a plurality of (for example 10 or more) particles that are grasped from the cross-sectional observation image and selected optionally. Moreover, the term “average primary particle diameter” refers to the arithmetic average value of major axes of a plurality of (for example 10 or more) primary particles that are grasped from the cross-sectional observation image and selected optionally.

The first coating part 4 coats a surface of a part of the Ni-containing lithium transition metal complex oxide 2. In other words, a surface of a part of the Ni-containing lithium transition metal complex oxide 2 is not coated with the first coating part 4. This makes it difficult to interrupt Li transfer in the Ni-containing lithium transition metal complex oxide 2, and accordingly, the resistance of the positive electrode can be reduced more. Furthermore, the output characteristic can be improved more. The first coating part 4 is attached to the Ni-containing lithium transition metal complex oxide 2 by physical and/or chemical bonding typically. The first coating part 4 is preferably fixed (for example, fused) to the Ni-containing lithium transition metal complex oxide 2 by sintering or the like.

The first coating part 4 includes a coating oxide including a lithium element and a coating element. In this embodiment, the coating element is at least one element among manganese (Mn), cobalt (Co), molybdenum (Mo), tin (Sn), and titanium (Ti). In particular, the coating element preferably includes at least one kind among Co, Sn, and Ti. In some embodiments, the coating element is preferably an element included in the Ni-containing lithium transition metal complex oxide 2. For example, in the case where the Ni-containing lithium transition metal complex oxide 2 includes Co, the coating element preferably includes Co and more preferably is Co. Thus, the resistance at an interface between the Ni-containing lithium transition metal complex oxide 2 and the first coating part 4 can be reduced more and the effect of the art disclosed herein can be achieved at a higher level. In some other embodiments, the coating element preferably includes Sn, and more preferably is Sn. Thus, the durability can be increased further and the effect of the art disclosed herein can be achieved at the higher level.

Specific examples of the coating oxide include lithium manganese complex oxides, lithium cobalt complex oxides, lithium cobalt manganese complex oxides, lithium molybdenum complex oxides, lithium tin complex oxides, lithium titanium complex oxides, and the like. Any of these may be used alone, or two or more kinds thereof may be used in combination. The coating oxide may include the lithium element, the coating element, and an oxygen element (O), or may additionally include, for example, one kind or two or more kinds of elements other than those above.

In some embodiments, the coating oxide preferably has a composition expressed by the following Formula (II):

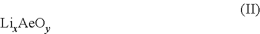

Ae in Formula (II) above is the coating element (that is, at least one kind of element selected from the group consisting of Mn, Co, Mo, Sn, and Ti) and x and y are positive numerals (typically integers). Specific examples of the coating oxide include LiMnO₄, LiCoMnO₄, LiCoO₂, Li₂MoO₃, Li₂MoO₄, LiSnO, LiTiO₂, and the like.

Note that the coating oxide can be manufactured by attaching and sintering a coating oxide source (for example, metal oxide) including the coating element on the surface of the Ni-containing lithium transition metal complex oxide 2 in a particle form, for example, which will be described in detail in a manufacturing method below. Specifically, at the sintering, a part of Li included in the Ni-containing lithium transition metal complex oxide 2 shifts to the coating oxide source. Thus, the coating oxide source changes into the coating oxide including Li. Note that the coating oxide including Li can be confirmed by detection in accordance with, for example, X-ray photoelectron spectroscopy (XPS).

In some embodiments, the coating oxide of the first coating part 4 is preferably formed of a plurality of particles as illustrated in FIG. 1. The shape of each particle included in the coating oxide is substantially spherical here, although there is no particular limitation. An average particle diameter D₁ of the particles included in the coating oxide is preferably 0.01 to 1 μm, more preferably 0.02 to 0.5 μm, and still more preferably 0.05 to 0.3 μm. The average particle diameter D₁ is typically smaller than the average particle diameter Do of the Ni-containing lithium transition metal complex oxide 2 (D₁<D₀). A ratio (D₁/D₀) of the average particle diameter D₁ of the particles included in the coating oxide to the average particle diameter D₀ of the Ni-containing lithium transition metal complex oxide 2 is preferably 0.01 to 0.2, more preferably 0.02 to 0.1, and still more preferably 0.04 to 0.07.

The first coating part 4 may be formed of the coating oxide described above, or may additionally include another component. For example, a part of the first coating part 4 that is close to the Ni-containing lithium transition metal complex oxide 2 may further include a compound including an element derived from the Ni-containing lithium transition metal complex oxide 2. The ratio of the coating oxide in the entire first coating part 4 on the basis of the mass is preferably 80 mass % or more, more preferably 90 mass % or more, and particularly preferably 95 mass % or more (that is, the first coating part 4 is substantially formed of the coating oxide).

In this embodiment, the first coating part 4 is provided in an island (spot) shape on the surface of the Ni-containing lithium transition metal complex oxide 2 as illustrated in FIG. 1. The ratio of the part of the surface of the Ni-containing lithium transition metal complex oxide 2 that is coated with the first coating part 4 (the coating ratio of the first coating part 4) is less than 100%. In some embodiments, the coating ratio of the first coating part 4 is preferably 95% or less, more preferably 90% or less, and still more preferably 85% or less. When the coating ratio is the predetermined value or less, the resistance of the positive electrode can be reduced at a high level. In addition, the coating ratio of the first coating part 4 is preferably about 50% or more, more preferably 60% or more, and particularly preferably 65% or more. When the coating ratio is the predetermined value or more, the progress of the side reaction or the gas generation can be suppressed even in high-temperature preservation, for example. Therefore, the durability can be improved more and the excellent output characteristic can be achieved for a longer time.

Note that the attachment of the first coating part 4 on the surface of the Ni-containing lithium transition metal complex oxide 2 and the ratio of the part of the surface of the Ni-containing lithium transition metal complex oxide 2 that is coated with the first coating part 4 (the coating ratio of the first coating part 4) can be checked by, for example, XPS performed on the positive electrode active material 10. The specific measurement conditions of the XPS will be shown in Examples below.

In some embodiments, in the Raman spectrum of the first coating part 4 that is measured based on laser Raman spectroscopy, a ratio (I_{Ni}/I_{M}) of an intensity I_{M} of the coating element to an intensity I_{Ni} of nickel appearing near 550 cm⁻¹ (in the Ni-containing lithium transition metal complex oxide 2) is preferably 2.7 or less. For example, in the case where the first coating part 4 includes cobalt as the coating element, a ratio (I_{Ni}/I_{Co}) of an intensity I_{Co} of cobalt (as the coating element) appearing near 486 cm⁻¹ to the intensity I_{Ni} of nickel appearing near 550 cm⁻¹ (in the Ni-containing lithium transition metal complex oxide 2) is preferably 2.7 or less. Thus, the progress of the side reaction or the gas generation can be suppressed even in high-temperature preservation, for example. Therefore, the durability can be improved more and the excellent output characteristic can be achieved for a long time.

The second coating part 6 coats the surface of at least a part of the first coating part 4 and the Ni-containing lithium transition metal complex oxide 2, and forms an outer surface of at least a part of the positive electrode active material 10. The second coating part 6 is provided so as to be in contact with the part of the surface of the Ni-containing lithium transition metal complex oxide 2 where the first coating part 4 is not formed. The second coating part 6 is attached to the Ni-containing lithium transition metal complex oxide 2 or the first coating part 4 typically by physical and/or chemical bonding. The second coating part 6 is preferably fixed (for example, fused) to the Ni-containing lithium transition metal complex oxide 2 or the first coating part 4 by sintering or the like.

The second coating part 6 includes a boron (B)-containing compound. Thus, the progress of the side reaction or the gas generation can be suppressed even in high-temperature preservation, for example. Therefore, the durability can be improved suitably, and the excellent output characteristic can be achieved for a long time. The boron-containing compound is typically in a state of oxide or hydroxide including a boron element (B) and an oxygen element (O). Specific examples of the boron-containing compound include boric acid (B(OH)₃), boron oxide (B₂O₃), C₆H₅B(OH)₂, (C₆H₅O)₃B, [CH₃(CH₂)₃O]₃B, C₁₁₃H₁₉BO₃, C₃H₉B₃O₆, (C₃H₇O)₃B, and the like.

Note that the boron-containing compound can be manufactured by, for example, mixing the Ni-containing lithium transition metal complex oxide 2 including the first coating part 4 with a boron source and then sintering the mixture, which will be described in detail in a manufacturing method below. Therefore, the boron-containing compound may further include an element derived from the Ni-containing lithium transition metal complex oxide 2 (for example, Li) in a part that is close to the Ni-containing lithium transition metal complex oxide 2, for example. Moreover, in a part that is close to the first coating part 4, for example, an element derived from the coating oxide (for example, Li or the coating element) may be further included. In some embodiments, the boron-containing compound may be, for example, boron lithium oxide expressed by LiBO₂, Li₂B₄O₇, or the like.

In some embodiments, the boron-containing compound preferably has an amorphous phase. Thus, particularly in the part of the surface of the Ni-containing lithium transition metal complex oxide 2 where the first coating part 4 is not formed, the side reaction between the Ni-containing lithium transition metal complex oxide 2 and the electrolyte can be suppressed suitably. Therefore, the durability can be increased further and the effect of the art disclosed herein can be achieved at the higher level. Note that the boron-containing compound in the amorphous phase can be manufactured suitably by adjusting the sintering temperature to be described below.

The second coating part 6 may be formed of the aforementioned boron-containing compound or may further include another component. For example, in the part that is close to the Ni-containing lithium transition metal complex oxide 2 or the first coating part 4, the element derived from the Ni-containing lithium transition metal complex oxide 2 or the first coating part 4 may be further included. The ratio of the boron-containing compound in the entire second coating part 6 on the basis of the mass is preferably 80 mass % or more, more preferably 90 mass % or more, and particularly preferably 95 mass % or more (that is, the second coating part 6 is substantially formed of the boron-containing compound).

The average thickness of the second coating part 6 is preferably 5 to 200 nm, more preferably 10 to 100 nm, and still more preferably 20 to 50 nm. When the average thickness is the predetermined value or more, for example in the part where the first coating part 4 is not formed, the side reaction between the Ni-containing lithium transition metal complex oxide 2 and the electrolyte can be suppressed suitably. Therefore, the progress of the side reaction or the gas generation can be suppressed even in high-temperature preservation, for example, and the durability can be improved more. In addition, when the average thickness is the predetermined value or less, Li transfer in the Ni-containing lithium transition metal complex oxide 2 is interrupted less easily, so that the resistance of the positive electrode can be reduced more and the output characteristic can be improved more. Note that “the average thickness” is grasped from a cross-sectional observation image of an electron microscope (for example, transmission electron microscope), and corresponds to the arithmetic average value of the thicknesses at a plurality of (for example, 10 or more) positions selected optionally.

In this embodiment, in the part of the surface of the Ni-containing lithium transition metal complex oxide 2 where the first coating part 4 is not provided, a region on the outermost surface is measured by XPS. In this region, when the total concentration of the metal elements other than lithium included in the Ni-containing lithium transition metal complex oxide 2 and the boron element included in the second coating part 6 is 100 mol %, the boron coating ratio obtained as the ratio of the concentration of the boron element is 90 mol % or more. The boron coating ratio is an index expressing the ratio of the region where the second coating part 6 is provided. That is to say, in the positive electrode active material 10 disclosed herein, the part of the surface of the Ni-containing lithium transition metal complex oxide 2 where the first coating part 4 is not provided is mostly coated with the second coating part 6. In other words, in the part of the surface of the Ni-containing lithium transition metal complex oxide 2 where the first coating part 4 is not provided, the exposure of the Ni-containing lithium transition metal complex oxide 2 is suppressed to be low. Thus, the progress of the side reaction or the gas generation can be suppressed suitably even in high-temperature preservation. Therefore, the durability can be improved and the excellent output characteristic can be achieved for a long time.

The boron coating ratio is preferably 91% or more and more preferably 92% or more because the effect of the art disclosed herein can be achieved at the higher level. As the boron coating ratio, XPS is conducted at a plurality of points and its arithmetic average value is preferably employed. The specific measurement conditions of XPS will be shown in Examples below.

In some embodiments, the boron coating ratio is preferably 99.9% or less, more preferably 99% or less, still more preferably 98% or less, for example 96% or less, and particularly preferably 95% or less. Thus, Li transfer in the Ni-containing lithium transition metal complex oxide 2 is interrupted less easily, so that the resistance of the positive electrode can be reduced more. Accordingly, the output characteristic can be improved more. Note that the boron coating ratio can be adjusted suitably by, for example, the mixing ratio of the boron source, the mixing method, the sintering condition (in particular, sintering temperature), or the like in the manufacturing method to be described below.

### [Manufacturing Method for Positive Electrode Active Material]

The positive electrode active material 10 described above can be manufactured by, for example, the manufacturing method including the following steps in this order: (S0) a preparing step for the Ni-containing lithium transition metal complex oxide 2; (S1) a first coating step of forming the first coating part 4; and (S2) a second coating step of forming the second coating part 6. The manufacturing method disclosed herein may further include another step at an optional stage.
(S0) The preparing step is a step of preparing the Ni-containing lithium transition metal complex oxide 2 in the particle form serving as the base material. The Ni-containing lithium transition metal complex oxide 2 in the particle form can be manufactured by a conventionally known method (for example, a crystallization method of obtaining single-crystal particles) or be prepared by purchasing a commercial product.
(S1) The first coating step is a step of forming the first coating part 4 on the surface of a part of the prepared Ni-containing lithium transition metal complex oxide 2. In a preferred embodiment, this step includes (S1-1) a first mixing step and (S1-2) a first sintering step in this order. Moreover, this step may further include another step at an optional stage.
(S1-1) The first mixing step is a step of obtaining a first mixture by mixing the Ni-containing lithium transition metal complex oxide 2 and the coating oxide source. The coating oxide source is a compound including the coating element. The coating oxide source may be an oxide including the coating element (metal oxide). Examples of the coating oxide source include manganese oxide, cobalt oxide, molybdenum oxide, tin oxide, titanium oxide, and the like. The coating oxide source is preferably in a powder form (particle form).

The mixing method is not limited in particular and conventionally known dry mixing or wet mixing can be employed as appropriate. The dry mixing is preferable in particular. Thus, the coating oxide source can be easily attached unevenly (in the island shape) to the surface of the Ni-containing lithium transition metal complex oxide 2. A mixing device is not limited in particular and may be, for example, a ball mill, a bead mill, a jet mill, a planetary mixer, a disperser, or the like. In particular, the ball mill (for example, a planetary ball mill) is preferable.

In some embodiments, it is preferable to combine the Ni-containing lithium transition metal complex oxide 2 and the coating oxide source in a mechanochemical process. Thus, the coating oxide source is easily attached firmly to the surface of the Ni-containing lithium transition metal complex oxide 2. In addition, in the first sintering step to be described below, a part of lithium included in the Ni-containing lithium transition metal complex oxide 2 easily transfers to the coating oxide source. Note that, in this specification, “the mechanochemical process” refers to a process of coupling materials physically (mechanically) by applying mechanical energy such as a compression force, a shear force, or a friction force to the materials in the powder form. Thus, the Ni-containing lithium transition metal complex oxide 2 and the coating oxide source are integrated in the particle form and complex particles are formed.

The mixing ratio between the Ni-containing lithium transition metal complex oxide 2 and the coating oxide source is preferably adjusted so that the coating ratio of the first coating part 4 is in the aforementioned range. Typically, the mass of the Ni-containing lithium transition metal complex oxide 2 is larger than the mass of the coating oxide source. In some embodiments, when the mass of the Ni-containing lithium transition metal complex oxide 2 is 100 parts by mass, the mass of the coating oxide source may be about 1 to 10 parts by mass and is preferably 3 to 5 parts by mass. Thus, the coating oxide source is easily attached unevenly (in the island shape) to the surface of the Ni-containing lithium transition metal complex oxide 2.
(S1-2) The first sintering step is a step of sintering the first mixture obtained by the first mixing step at a temperature of 600 to 700° C. in the presence of oxygen. According to the present inventor's examination, setting the sintering temperature in the aforementioned range makes it easier to melt the coating oxide source (coating element) suitably and fix (for example, fuse) the coating oxide source to the surface of the Ni-containing lithium transition metal complex oxide 2. In addition, the sintering makes it easier to shift a part of lithium included in the Ni-containing lithium transition metal complex oxide 2 to the coating oxide source. That is to say, by sintering with the coating oxide source present on the surface of the Ni-containing lithium transition metal complex oxide 2, the coating oxide source can be changed suitably into the coating oxide (the first coating part) including lithium and the coating element.

The sintering time may be about 1 to 24 hours and is preferably 2 to 12 hours, although there is no particular limitation. The sintering atmosphere is preferably an oxygen-containing atmosphere, for example an oxygen atmosphere or an air atmosphere. In this manner, the coating oxide is attached to the surface of a part of the Ni-containing lithium transition metal complex oxide 2 as the base material and thus, a first sintered substance including the first coating part 4 can be manufactured.
(S2) The second coating step is a step of forming the second coating part 6 on a surface of the first sintered substance manufactured above. In a preferred embodiment, this step includes (S2-1) a second mixing step and (S2-2) a second sintering step in this order. Moreover, this step may further include another step at an optional stage.
(S2-1) The second mixing step is a step of mixing the first sintered substance and the boron source to obtain a second mixture. The boron source is a compound including the boron element. Examples of the boron source include boric acid (B(OH)₃). Boric acid may be in the powder form or, for example, a liquid state in which boric acid is dissolved in water or the like. The mixing method is not limited in particular and, for example, the conventionally known dry mixing or wet mixing as given above regarding the first mixing step can be employed as appropriate. The dry mixing is preferable in particular.

The mixing ratio between the first sintered substance and the boron source is preferably adjusted so that the thickness of the second coating part 6 is in the aforementioned range, for example. Typically, the mass of the first sintered substance is larger than the mass of the boron source. In some embodiments, when the mass of the Ni-containing lithium transition metal complex oxide 2 is 100 parts by mass, the mass of the boron source may be about 0.3 to 2 parts by mass and is preferably 0.4 to 1.2 parts by mass.
(S2-2) The second sintering step is a step of sintering the second mixture obtained in the second mixing step at a temperature of 250 to 350° C. (300±50° C.) in the presence of oxygen. According to the present inventor's examination, setting the sintering temperature in the aforementioned range makes it easier to adjust the boron coating ratio in the aforementioned range suitably. Specifically, when the sintering temperature is the predetermined value or less, the boron source easily reacts on the surface of the particle and the boron coating ratio can be increased. Moreover, when the sintering temperature is the predetermined value or more, the aggregation between the particles can be suppressed and the filling property can be increased. In addition, the boron compound can be suitably changed into the amorphous phase state.

The sintering time may be about 1 to 24 hours and is preferably 3 to 12 hours, although there is no particular limitation. The sintering atmosphere is preferably the oxygen-containing atmosphere, for example the oxygen atmosphere or the air atmosphere. In this manner, the boron compound can be attached to the surface of the first sintered substance and the positive electrode active material 10 disclosed herein can be manufactured.

### [Electrical Energy Storage Device]

FIG. 2 is a cross-sectional view schematically illustrating an internal structure of an electrical energy storage device 100 according to an embodiment. The electrical energy storage device 100 illustrated in FIG. 2 is a prismatic battery in which a flat electrode body 20 and a nonaqueous electrolyte 80 are accommodated within a flat and rectangular battery case 30. The electrical energy storage device 100 is characterized by including the positive electrode active material 10 described above in the electrode body 20 (specifically, a positive electrode sheet 50 to be described below). Therefore, the other structure may be similar to the conventional structure. Note that FIG. 2 illustrates one example and the present disclosure is not limited to the illustrated example. The electrical energy storage device may be a coin type, a button type, a cylindrical type, a laminate case type, or the like in another embodiment.

The battery case 30 is an exterior container for accommodating the electrode body 20 and the nonaqueous electrolyte 80. As the material of the battery case 30, for example, a metal material with small weight and high thermal conductivity, such as aluminum, is used. On an outer surface of the battery case 30, a positive electrode terminal 42 and a negative electrode terminal 44 for external connection, and a thin safe valve 36 that is set to, when the internal pressure of the battery case 30 has risen to or above a predetermined level, release the internal pressure are provided. The positive electrode terminal 42 is electrically connected to a positive electrode current collection plate 42a, and the negative electrode terminal 44 is electrically connected to a negative electrode current collection plate 44a.

Here, the electrode body 20 is a wound electrode body in which the positive electrode sheet 50 and a negative electrode sheet 60 are overlapped on each other through two separator sheets 70 with a band shape and wound in a longitudinal direction. In another embodiment, however, the electrode body may be a stack type electrode body formed in such a way that a rectangular positive electrode and a rectangular negative electrode are stacked through a rectangular separator. The positive electrode sheet 50 has a structure in which a positive electrode active material layer 54 is formed along the longitudinal direction on one surface or both surfaces (here, both surfaces) of a positive electrode current collector 52 with a band shape as illustrated in a partially ruptured view of FIG. 2. The negative electrode sheet 60 has a structure in which a negative electrode active material layer 64 is formed along the longitudinal direction on one surface or both surfaces (here, both surfaces) of a negative electrode current collector 62 with a band shape.

At both end parts of the electrode body 20 in a winding axis direction (that is, a width direction orthogonal to the longitudinal direction), a positive electrode active material layer non-formation part 52a where the positive electrode active material layer 54 is not formed and the positive electrode current collector 52 is exposed and a negative electrode active material layer non-formation part 62a where the negative electrode active material layer 64 is not formed and the negative electrode current collector 62 is exposed are formed in a manner of protruding outward. Each of the positive electrode active material layer non-formation part 52a and the negative electrode active material layer non-formation part 62a functions as a current collection part. The positive electrode active material layer non-formation part 52a and the negative electrode active material layer non-formation part 62a include the positive electrode current collection plate 42a and the negative electrode current collection plate 44a, respectively. Note that the shape of the positive electrode active material layer non-formation part 52a and the negative electrode active material layer non-formation part 62a is not limited to the shape illustrated in the drawing. Each of the positive electrode active material layer non-formation part 52a and the negative electrode active material layer non-formation part 62a may be formed as a current collection tab that is processed into a predetermined shape.

The positive electrode current collector 52 has a band shape. The positive electrode current collector 52 is preferably made of metal, and more preferably made of a metal foil. The positive electrode current collector 52 is an aluminum foil here. The positive electrode active material layer 54 includes at least the aforementioned positive electrode active material 10. The positive electrode active material layer 54 may include a positive electrode active material of the kind other than the aforementioned positive electrode active material 10. When the entire positive electrode active material in the positive electrode active material layer 54 is 100 mass %, the ratio of the aforementioned positive electrode active material 10 may be generally 50 mass % or more, preferably 60 mass % or more, more preferably 80 mass % or more, and for example 85 to 100 mass %. Thus, the effect of the art disclosed herein can be obtained at the high level.

In some embodiments, the positive electrode active material layer 54 preferably includes a second positive electrode active material in addition to the positive electrode active material 10 described above. The second positive electrode active material is an active material that includes neither the first coating part 4 nor the second coating part 6 described above. The second positive electrode active material is preferably a lithium transition metal complex oxide and more preferably a Ni-containing lithium transition metal complex oxide. As the second positive electrode active material, for example, a compound given as the example of the Ni-containing lithium transition metal complex oxide 2 of the positive electrode active material 10 can be used as appropriate.

In some embodiments, the second positive electrode active material is preferably in a secondary particle form in which a plurality of primary particles are aggregated with a physical or chemical bonding power. That is to say, the second positive electrode active material is preferably a group of the primary particles (aggregated particles) in which a number of primary particles are gathered to form one particle. The number of primary particles constituting the second positive electrode active material is typically 20 or more, for example 30 or more, preferably 100 or more, more preferably several hundred or more, and for example 1000 or more. The upper limit value of the number of primary particles constituting the second positive electrode active material is not limited in particular and is typically 20000 or less.

The positive electrode active material layer 54 may additionally include an additive component other than the positive electrode active material. Examples of the additive component include a conductive material, a binder, trilithium phosphate, and the like. Examples of the conductive material include carbon black such as acetylene black (AB) and carbon materials such as graphite. Examples of the binder include fluorine resins such as polyvinylidene fluoride (PVdF).

When the entire positive electrode active material layer 54 is 100 mass %, the ratio of the positive electrode active material is preferably 70 mass % or more, more preferably 80 to 99 mass %, and still more preferably 85 to 98 mass %, without particular limitations. The ratio of the conductive material is preferably 0.5 to 15 mass %, for example 1 to 10 mass %, and more preferably 1 to 5 mass %. The ratio of the binder is preferably 0.5 to 15 mass %, for example 0.8 to 10 mass %, and more preferably 1 to 5 mass %.

The negative electrode current collector 62 has a band shape. The negative electrode current collector 62 is preferably made of metal, and more preferably made of a metal foil. The negative electrode current collector 62 is a copper foil here. The negative electrode active material layer 64 includes a negative electrode active material. As the negative electrode active material, for example, a Si-containing material such as Si, SiO (silicon oxide), or SiC (silicon carbide), or a carbon material such as graphite, hard carbon, or soft carbon can be used. The negative electrode active material layer 64 may include an additive component other than the negative electrode active material. Examples of the additive component include a binder, a thickener, and the like. Examples of the binder include rubbers such as styrene butadiene rubber (SBR) and fluorine resins such as polyvinylidene fluoride (PVdF). Examples of the thickener include celluloses such as carboxymethyl cellulose (CMC).

The separator sheet 70 has a band shape. The separator sheet 70 may be, for example, a porous sheet (film) made of resin such as polyethylene (PE), polypropylene (PP), or polyester. Such a porous sheet may have a single-layer structure or a multilayer structure of two or more layers (for example, three-layer structure in which a PP layer is stacked on each surface of a PE layer). The separator sheet 70 may have a heat-resistant layer (HRL) on a surface thereof.

The nonaqueous electrolyte 80 is typically a nonaqueous electrolyte solution containing a nonaqueous solvent and a supporting salt (electrolyte salt). In another embodiment, however, the nonaqueous electrolyte 80 may be a polymer electrolyte. As the nonaqueous solvent, any of various kinds of organic solvents including carbonates, ethers, esters, and the like that are usable for electrolyte solutions of general electrical energy storage devices can be used alone or two or more kinds thereof can be used as appropriate in combination. Specific examples include ethylene carbonate (EC), propylene carbonate (PC), diethyl carbonate (DEC), dimethyl carbonate (DMC), ethyl methyl carbonate (EMC), and the like. Examples of the supporting salt include lithium salts such as LiPF₆ and LiBF₄.

The electrical energy storage device 100 is usable in various applications, and for example, can be suitably used as a motive power source for a motor (power source for driving) that is mounted in a vehicle such as a passenger car or a truck because of being able to exhibit the excellent output characteristic for a long time. The vehicle is not limited to a particular type, and may be, for example, a plug-in hybrid electric vehicle (PHEV), a hybrid electric vehicle (HEV), or a battery electric vehicle (BEV).

Examples of the present disclosure are hereinafter described but it is not intended to limit the present disclosure to the examples below.

### <Manufacture of Positive Electrode Active Material>

[Examples 1 to 5] In Examples 1 to 5, as the positive electrode active material, a complex in which the first coating part and the second coating part were formed was manufactured on the surface of the Ni-containing lithium transition metal complex oxide corresponding to the base material. That is to say, first, a lithium nickel cobalt manganese complex oxide (NCM, single particle form) expressed by Li_{1.05}Ni_{0.83}Co_{0.06}Mn_{0.1}O₂ in the particle form was prepared as the Ni-containing lithium transition metal complex oxide (preparing step).

Next, the Ni-containing lithium transition metal complex oxide and the metal oxide shown in Table 1 (the coating oxide source including the coating element) were mixed in a dry procedure (first mixing step). Specifically, the Ni-containing lithium transition metal complex oxide and the metal oxide shown in Table 1 were put into a container made of zirconia, and the mixture was subjected to a mechanochemical process together with zirconia balls of Φ3 mm for a predetermined time using a P5 planetary ball mill made by Fritsch. Note that, regarding the mixing ratio, the metal oxide was used by 0.5 to 0.7 parts by mass per 100 parts by mass of the Ni-containing lithium transition metal complex oxide. Thus, the first mixture was obtained.

The resulting first mixture was sintered for three hours at 600 to 700° C. in the oxygen atmosphere (first sintering step). Thus, the metal oxide was fixed on the surface of the Ni-containing lithium transition metal complex oxide and moreover, a part of lithium included in the Ni-containing lithium transition metal complex oxide was transferred to the metal oxide. In this manner, the coating oxide (for example, the lithium cobalt oxide, the first coating part in Examples 1 to 3) including lithium and the coating element was formed on the surface of a part of the Ni-containing lithium transition metal complex oxide and thus, the first sintered substance was obtained.

As for the first sintered substance, the ratio (coating ratio) of the part of the surface of the Ni-containing lithium transition metal complex oxide that is coated with the coating oxide (the first coating part) was measured by the laser Raman spectroscopy. The results are shown in Table 1.

Next, the obtained first sintered substance and boric acid as the boron source were mixed in the dry procedure (second mixing step). Note that regarding the mixing ratio, the boric acid was used by 0.5 to 0.8 parts by mass per 100 parts by mass of the Ni-containing lithium transition metal complex oxide. Thus, the second mixture was obtained.

Then, the obtained second mixture was sintered for five hours at 250 to 350° C. in the oxygen atmosphere (second sintering step). Thus, the second coating part including a boron-containing oxide (boron-containing oxide glass) that was combined in an amorphous phase was formed on the surface of at least a part of the first sintered substance. In this manner, the positive electrode active material was manufactured.

### <Evaluation 1 of Positive Electrode Active Material (XPS)>

Regarding the obtained positive electrode active material, a part of the surface of the NCM as the base material where the first coating part was not provided was subjected to XPS under the following conditions:
Device: PHI 5000 VersaProbe II (manufactured by ULVAC-PHI)
X-ray source: AlKα monochromatic light (1486.6 eV)
Acceleration voltage: 20 kV
Electric power: 100 W
Measurement mode: wide scanning
Detection angle: 45°

Next, the composition of the measurement elements was analyzed and the amount of presence (mol) of each element in a region of an outermost surface (with a depth of about 10 nm) was calculated. As the ratio (mol %) of the concentration of boron to the total concentration of boron and the metal elements (here, the transition metal element) excluding Li included in the positive electrode active material, the boron coating ratio was calculated. More specifically, since the base material is formed of the aforementioned NCM here, the total concentration of boron and the metal elements excluding Li included in the positive electrode active material is expressed as the total concentration of Ni, Co, Mn, and B. Therefore, the boron coating ratio [%] was calculated from {B/(Ni+Co+Mn+B)}×100. The results are shown in Table 1.

### <Evaluation 2 of Positive Electrode Active Material (Laser Raman)>

The positive electrode active material was subjected to laser Raman spectroscopy under the following conditions:
Device: laser Raman microscope RAMANtouch (manufactured by Nanophoton)
Measurement atmosphere: Non-exposure to atmosphere (Ar atmosphere)
Measurement region: about 200×200 μm
Pixel size: 400 nm
Laser wavelength: 532 nm
Laser power: 0.2 mW
Slit width: 50 μm
Diffraction grating: 600 gr/mm

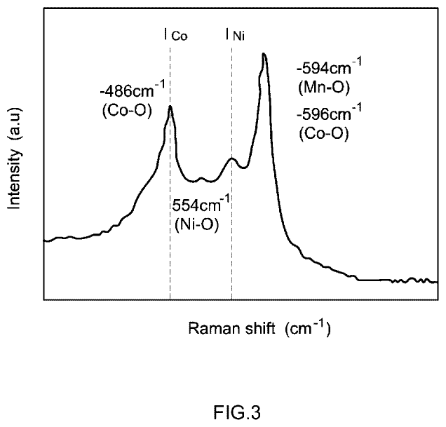

FIG. 3 shows the Raman spectrum in Example 1. In FIG. 3, the horizontal axis represents the wave number difference between incident light and scattering light (that is, Raman shift) and the vertical axis represents the scattering intensity (relative value). Next, peak separation is performed in such a Raman spectrum and the ratio (I_{Ni}/I_{M}) of the intensity I_{M} of the coating element to the intensity I_{Ni} of nickel appearing near 550 cm⁻¹ was calculated as a Raman peak ratio. For example, in Example 1, the first coating part was formed of a lithium cobalt oxide and the coating element was Co; therefore, a ratio (I_{Ni}/I_{Co}) of the intensity I_{Co} of cobalt (Co—O) appearing near 486 cm⁻¹ to the intensity I_{Ni} of nickel (Ni—O) appearing at 554 cm⁻¹ was calculated as the Raman peak ratio. The results are shown in Table 1.

[Comparative Examples 1 to 3] In Comparative Example 1, the positive electrode active material was obtained in such a way that the first coating part was not formed and only the second coating part was formed in accordance in Example 1 in the lithium nickel cobalt manganese complex oxide (NCM) with the aforementioned composition. In Comparative Example 2, the positive electrode active material was obtained in such a way that only the first coating part was formed in accordance in Example 1 and the second coating part was not formed in the lithium nickel cobalt manganese complex oxide (NCM) with the aforementioned composition. In Comparative Example 3, the positive electrode active material was obtained in a manner similar to Example 1 except that the boron coating ratio was decreased by decreasing the ratio (mixing amount) of boric acid in the second mixing step. Then, the evaluation with XPS and laser Raman was performed in a manner similar to Example 1. The results are shown in Table 1.

### <Manufacture of Lithium Ion Secondary Battery for Evaluation>

First, the second positive electrode active material that includes neither the first coating part nor the second coating part was prepared. Specifically, first, a nickel cobalt manganese complex hydroxide expressed by Ni_{0.83}Co_{0.05}Mn_{0.12}(OH)₂ was obtained in accordance with a conventionally known co-precipitation method. Next, the obtained nickel cobalt manganese complex hydroxide was sintered with a Li source and lithium hydroxide for 10 hours at 800° C. in an oxygen atmosphere. Then, the obtained sintered substance was pulverized to prepare the lithium nickel cobalt manganese complex oxide (NCM, aggregated particles).

Subsequently, the positive electrode active material (single particles) in Examples 1 to 4 and Comparative Examples 1 to 3 and the second positive electrode active material (aggregated particles) were mixed in a mass ratio of 40:60 to prepare a mixture active material. Next, the mixed active material, acetylene black (AB) as the conductive material, and polyvinylidene fluoride (PVdF) as the binder were mixed in a mass ratio of the mixed active material:AB:PVdF=100:1:1, and a suitable amount of N-methyl-2-pyrrolidone (NMP) was added; thus, a positive electrode active material layer formation slurry was prepared. This positive electrode active material layer formation slurry was applied on an aluminum foil (positive electrode current collector) and dried, so that the positive electrode active material layer was formed. Then, the positive electrode active material layer was roll-pressed with a roller and cut into a predetermined size; thus, the positive electrode sheet was manufactured.

In addition, graphite (C) as the negative electrode active material, styrene butadiene rubber (SBR) as the binder, and carboxyl methyl cellulose (CMC) as the thickener were mixed in a mass ratio of C:SBR:CMC=100:1:1 and a suitable amount of an ion exchanged water was added thereto, and thus a negative electrode active material layer formation slurry was prepared. This negative electrode active material layer formation slurry was applied on a copper foil (negative electrode current collector) and dried; thus, the negative electrode active material layer was formed. Then, the negative electrode active material layer was roll-pressed with the roller and cut into a predetermined size; thus, the negative electrode sheet was manufactured.

As the separator, a porous polyolefin sheet with a three-layer structure of PP/PE/PP was prepared. Next, the positive electrode sheet and the negative electrode sheet were overlapped on each other with the separator therebetween; thus, the electrode body was manufactured. Next, the electrode body was inserted into the battery case formed of an aluminum laminate film, and the nonaqueous electrolyte solution was injected. Note that, as the nonaqueous electrolyte solution, a nonaqueous electrolyte solution in which LiPF₆ as the supporting salt was dissolved at a concentration of 1 mol/L in a mixed solvent including ethylene carbonate (EC) and ethyl methyl carbonate (EMC) in a volume ratio of EC:EMC=1:3 was used. After that, the battery case was sealed; thus, an evaluation cell (lithium ion secondary battery) was obtained.

### <Evaluation of Initial Internal Resistance>

The state of charge of each evaluation cell was adjusted to an SOC of 10%, and constant-current discharging was performed for 10 seconds with a constant current of 3 C in a −10° C. environment. Then, based on the difference (voltage drop amount) between a voltage (V0) just before the discharging and a voltage (V1) 10 seconds after the discharging and the discharging current value, the initial internal resistance (Rᵢₙᵢₜᵢₐₗ) was calculated in accordance with: Rᵢₙᵢₜₐₗ=(V0−V1)/3C current value. The results are shown in Table 1.

### <Evaluation of High-Temperature Preservation Characteristic>

A high-temperature preservation characteristic of each evaluation cell was evaluated. Since the side reaction can be accelerated in a high-temperature environment, the high-temperature preservation characteristic is widely employed in an acceleration test for lifetime determination. Specifically, first, each evaluation cell was adjusted to 4.2 V and preserved for 60 days in a 70° C. environment. Then, regarding each evaluation cell after the high-temperature preservation, the resistance (R_{after}) was obtained in a manner similar to Rᵢₙᵢₜᵢₐₗ, and the resistance increase ratio (%) was calculated in accordance with: Internal resistance increase ratio=[(R_{afte}−Rᵢₙᵢₜᵢₐₗ)/Rᵢₙᵢₜₐₗ]×100. The results are shown in Table 1.

Moreover, the volume change of the evaluation cell before and after the high-temperature preservation was measured by the Archimedes method and the amount of gas generation was obtained. The results are shown in Table 1. Note that Table 1 shows the relative values when the amount of gas generation in Comparative Example 2 is 100.

TABLE 1

| | | | Second coating | | | | | |
|---|---|---|---|---|---|---|---|---|
| | | | part | | | | Internal | |
| | First coating part | | | Boron | | | resistance | The |
| | Metal | Coating | | coating | Raman | | increase | amount of |
| | oxide | ratio | Boron | ratio | peak | Rᵢₙᵢₜᵢₐₗ | ratio | gas |
| | (M*) | (%) | coating | (%) | ratio | (Ω) | (%) | generation |
| Comparative | Absent | 0 | Present | 95.3 | — | 0.83 | 123 | 95 |
| Example 1 | | | | | | | | |
| Comparative | Cobalt | 65 | Absent | 0 | 2.3 | 0.34 | 162 | 100 |
| Example 2 | oxide | | | | | | | |
| Comparative | (Co) | 65 | Present | 75 | 2.3 | 0.32 | 214 | 96 |
| Example 3 | | | | | | | | |
| Example 1 | | 65 | Present | 95.3 | 2.2 | 0.34 | 123 | 78 |
| Example 2 | | 65 | Present | 99.8 | 1.9 | 0.42 | 117 | 78 |
| Example 3 | | 84 | Present | 94.2 | 3.1 | 0.31 | 133 | 81 |
| Example 4 | Titanium | 76 | Present | 92.3 | 3.2 | 0.36 | 125 | 80 |
| | oxide | | | | | | | |
| | (Ti) | | | | | | | |
| Example 5 | Tin | 82 | Present | 95.3 | 2.7 | 0.32 | 123 | 78 |
| | oxide | | | | | | | |
| | (Sn) | | | | | | | |

*M = Coating element

The results in Table 1 indicate that the initial resistance was high in the first place in Comparative Example 1 in which the first coating part was absent. In addition, the amount of gas generation after the high-temperature preservation was also large. On the other hand, in Comparative Examples 2 and 3 in which the boron coating ratio for the second coating part was low, Rᵢₙᵢₜᵢₐₗ remained low but the internal resistance increase ratio after the high-temperature preservation was high and moreover, the amount of gas generation was also large. In contrast to these Comparative Examples, Rᵢₙᵢₜₐₗ was relatively low and the high-temperature preservation characteristic was excellent in Examples 1 to 5. That is to say, the internal resistance increase ratio after the high-temperature preservation was suppressed and the amount of gas generation was also small. Therefore, in Examples 1 to 5, it is considered that the excellent output characteristic can be exhibited for a long time. These results indicate the technical meaning of the present disclosure.

The specific examples of the present disclosure have been described above in detail; however, these are examples and will not limit the scope of claims. The techniques described in the scope of claims include those in which the specific examples exemplified above are variously modified and changed.

As described above, the following items are given as specific aspects of the art disclosed herein.

Item 1: The positive electrode active material including: the Ni-containing lithium transition metal complex oxide in the particle form containing 70 mol % or more of nickel relative to the metal elements other than lithium; the first coating part that coats the surface of a part of the Ni-containing lithium transition metal complex oxide and includes the coating oxide including the lithium element and at least one coating element among manganese, cobalt, molybdenum, tin, and titanium; and the second coating part that coats the surface of at least a part of the first coating part and the Ni-containing lithium transition metal complex oxide and includes the boron-containing compound, in which the region of the outermost surface in the part of the surface of the Ni-containing lithium transition metal complex oxide where the first coating part is not provided is measured by the X-ray photoelectron spectroscopy and when the total of the metal elements other than lithium included in the Ni-containing lithium transition metal complex oxide and the boron element included in the second coating part in the region is 100 mol %, the boron coating ratio obtained as the ratio of the boron element is 90 mol % or more.

Item 2: The positive electrode active material according to Item 1, in which the Ni-containing lithium transition metal complex oxide is in the single particle form.

Item 3: The positive electrode active material according to Item 1 or 2, in which the Ni-containing lithium transition metal complex oxide further includes cobalt, and the coating element includes cobalt.

Item 4: The positive electrode active material according to any one of Items 1 to 3, in which the ratio of the part of the surface of the Ni-containing lithium transition metal complex oxide that is coated with the first coating part is 50% or more and 90% or less.

Item 5: The positive electrode active material according to any one of Items 1 to 4, in which the first coating part includes cobalt as the coating element and in the Raman spectrum measured by the laser Raman spectroscopy, the ratio (I_{Ni}/I_{Co}) of the intensity I_{Co} of cobalt as the coating element appearing near 486 cm⁻¹ to the intensity I_{Ni} of the nickel appearing near 550 cm⁻¹ is 2.7 or less.

Item 6: The positive electrode active material according to any one of Items 1 to 5, in which the boron-containing compound has the amorphous phase.

Item 7: The positive electrode active material according to any one of Items 1 to 6, in which the boron coating ratio is 98% or less.

Item 8: The positive electrode including the positive electrode active material layer, in which the positive electrode active material layer includes the positive electrode active material according to any one of Items 1 to 7, and the second positive electrode active material that includes neither the first coating part nor the second coating part.

Item 9: The positive electrode according to Item 8, in which the second positive electrode active material is in the secondary particle form.

Item 10: The electrical energy storage device including the positive electrode according to Item 8 or 9, the negative electrode, and the electrolyte.

What is claimed is:

1. A positive electrode active material comprising:
a Ni-containing lithium transition metal complex oxide in a particle form containing 70 mol % or more of nickel relative to metal elements other than lithium;
a first coating part that coats a surface of a part of the Ni-containing lithium transition metal complex oxide and includes a coating oxide including a lithium element and at least one coating element among manganese, cobalt, molybdenum, tin, and titanium; and
a second coating part that coats a surface of at least a part of the first coating part and the Ni-containing lithium transition metal complex oxide and includes a boron-containing compound, wherein a region of an outermost surface in a part of the surface of the Ni-containing lithium transition metal complex oxide where the first coating part is not provided is measured by X-ray photoelectron spectroscopy and when a total of the metal elements other than lithium included in the Ni-containing lithium transition metal complex oxide and the boron element included in the second coating part in the region is 100 mol %, a boron coating ratio obtained as a ratio of the boron element is 90 mol % or more.

2. The positive electrode active material according to claim 1, wherein the Ni-containing lithium transition metal complex oxide is in a single particle form.

3. The positive electrode active material according to claim 1, wherein
the Ni-containing lithium transition metal complex oxide further includes cobalt, and
the coating element includes cobalt.

4. The positive electrode active material according to claim 1, wherein a ratio of a part of the surface of the Ni-containing lithium transition metal complex oxide that is coated with the first coating part is 50% or more and 90% or less.

5. The positive electrode active material according to claim 1, wherein the first coating part includes cobalt as the coating element and in a Raman spectrum measured by laser Raman spectroscopy, a ratio (I_{Ni}/I_{Co}) of an intensity I_{Co} of cobalt as the coating element appearing near 486 cm⁻¹ to an intensity I_{Ni} of the nickel appearing near 550 cm⁻¹ is 2.7 or less.

6. The positive electrode active material according to claim 1, wherein the boron-containing compound has an amorphous phase.

7. The positive electrode active material according to claim 1, wherein the boron coating ratio is 98% or less.

8. A positive electrode comprising a positive electrode active material layer, wherein the positive electrode active material layer includes the positive electrode active material according to claim 1, and a second positive electrode active material that includes neither the first coating part nor the second coating part.

9. The positive electrode according to claim 8, wherein the second positive electrode active material is in a secondary particle form.

10. An electrical energy storage device comprising the positive electrode according to claim 8, a negative electrode, and an electrolyte.
